(19) United States
(12) Patent Application Publication
(10) Pub. No.: US 2011/0306718 A1
(43) Pub. Date: Dec. 15, 2011

(54) PULTRUSION PROCESS

(75) Inventors: Dietrich SCHERZER, Neustadt (DE); Andreas Wollny, Ludwigshafen (DE); Simone Schillo, Ludwigshafen (DE)

(73) Assignee: BASF SE, Ludwigshafen (DE)

(21) Appl. No.: 13/103,288

(22) Filed: May 9, 2011

Related U.S. Application Data
(60) Provisional application No. 61/333,295, filed on May 11, 2010.

(51) Int. Cl. C08L 77/00; C08K 3/04; C08K 3/40; B29C 67/24

(52) U.S. Cl. 524/538; 525/420; 264/171.1; 525/182

(57) ABSTRACT

The present invention relates to an improved pultrusion process for producing semifinished products based on polymers, in particular polyesters or polyamides, which comprises adding reactive chain extenders during the process of saturation (impregnation) of the fibers.

### DESCRIPTION

The present invention relates to an improved pultrusion process for producing semifinished products based on polymers, in particular polyesters or polyamides, which comprises adding reactive chain extenders during the process of saturation (impregnation) of the fibers.

### BACKGROUND

Pultrusion plants are used in order by way of example to produce monodirectionally fiber-reinforced profiles, or in order to produce long-fiber-reinforced pellets. FIG. 5 shows by way of example a plant of said type.

In pultrusion plants, very large amounts of fibers are intimately mixed and pultruded with reactive resins (epoxy, PU, RIM nylon), or with thermoplastics.

A detailed description of the plants and of the pultrusion process generally used is found in “Handbuch Verbundwerkstoffe” [Handbook of composite materials], Hanser Verlag 2004, edited by M. Neizel, page 237.

In these pultrusion plants it is difficult to achieve good saturation of large amounts of fiber bundles by thermoplastics of high viscosity. Attempts to achieve this frequently produce profiles or pellets with air inclusions, and only partially wetted fibers. The use of particularly low-viscosity polymers is an unsatisfactory solution because it impairs the mechanical properties of the semifinished products produced.

DE 10 2005 037 754 discloses a process for producing a polyester with an increased molecular weight, where a first polyester is compounded with a reactive compound, and this increases the molecular weight of the first polyester.

The processes and plants disclosed in the prior art for producing semifinished products via pultrusion therefore have disadvantages.

It was therefore the object of the present invention to provide an improved pultrusion process which can be used to avoid or eliminate the disadvantages and problems addressed above.

### EXPLANATIONS

For the purposes of the present invention, the terms “profile” and “semifinished product” are used synonymously.

The term “semifinished product” is an expression known to persons skilled in the art and is a generic expression for prefabricated forms of raw material, examples being panels, rods, tubes, strands, etc.

The term “pultrusion” means a method for producing composite materials, such as fiber-reinforced plastics, in the form of profiles, in a procedure which operates batchwise or continuously, preferably continuously.

Many different shapes of profiles can be produced here, examples being mats, tubes, supports, molded sections, e.g. for the automobile industry, for housings, grips, and shanks for a tool, and sports equipment, such as paddles and tennis rackets.

### FIGURES

FIG. 1 shows the results of experiment 1: Ultramid B® at 260 ° C.

FIG. 2 shows the results of experiment 2: Ultramid A® at 280 ° C.

FIG. 3 shows the results of experiment 3: Ultradur® at 260 ° C.

FIG. 4 shows the results of experiment 4: Ecoflex® at 220 ° C.

FIG. 5 shows by way of example a typical pultrusion plant, or a typical pultrusion process.

### DESCRIPTION OF THE INVENTION

The object was achieved by the present invention, by providing a pultrusion process for producing semifinished products, in particular based on polyesters and polyamides, which comprises adding reactive chain extenders during the saturation (impregnation) of the fibers. The process is suitable for all polymers having reactive end groups which react with reactive chain extenders based on epoxy, anhydride, or isocyanate groups.

Surprisingly, it has been found that the problems described during the saturation process using polyesters or polyamides can be solved by adding reactive chain extenders which preferably have isocyanate, epoxy, or acid functions. The fiber bundles or textiles are saturated with low-viscosity, low-molecular-weight polymers, while small amounts of reactive chain extenders are added simultaneously. During the pultrusion process, molecular weight then increases during and after the saturation of the fibers, and the desired good mechanical properties of the semifinished product or pellet material are obtained.

The present invention therefore provides a process for producing semifinished products based on polymers, in particular polyesters or polyamides, via pultrusion, which comprises adding reactive chain extenders during the saturation of the polymers fibers.

Examples of suitable products are the reactive chain extenders from BASF which are marketed with trademark Joncryl®. The chain extenders known as Joncryl® are copolymers of styrene and of glycidyl acrylates, or are copolymers of styrene and of anhydrides.

Table 1 lists by way of example some reactive chain extenders with trademark Joncryl®.

TABLE 1

| | Solid/ | | | | Eq. weight | |
|---|---|---|---|---|---|---|
| I. D. | liquid | Functionality | Polarity | Mw | (g/eg) | Tg |
| ADR4368F | Solid | Epoxy | High | 6800 | 280 | 64 |
| ADR4370S | Solid | Epoxy | High | 6800 | 280 | 54 |
| ADR4300 | Solid | Epoxy | Moderately | 5500 | 445 | 55 |
| | | | high | | | |
| ADR4380 | Liquid | Epoxy | | 3300 | 450 | −41 |
| ADR4385 | Liqid | Epoxy | Very high | 6000 | 450 | −37 |
| ADR-3300 | Solid | Acid | Very high | 3100 | 360 | 93 |
| ADR-3229 | Solid | Anhydride | Moderate | 8300 | 450 | 110 |

The process is decisively improved via addition of reactive chain extenders, e.g. Joncrylen® materials, having epoxy and maleic acid functions, because it is possible to use particularly low-viscosity (low-molecular-weight) thermoplastics while nevertheless achieving high molecular weights in the finished product.

By virtue of the specific pultrusion process of the invention, a feature of the semifinished products that can be produced thereby is that the reactive chain extenders used are incorporated into the polymers which form the basis of the semifinished products. The structure of the semifinished products that can be produced by the process of the invention therefore differs from the structure of semifinished products produced by means of processes of the prior art. The present application therefore further provides a semifinished product that can be produced by the pultrusion process of the invention.

The amounts added of the chain extenders are from 0.1% by weight to 10% by weight, preferably from 0.3 to 6% by weight, and very particularly preferably amounts of from 0.5% by weight to 5% by weight, based on the polymer.

Polyesters and polyamides are particular polymers that can be used for the process of the invention, as the basis of semifinished products. Examples that may be mentioned as suitable polyesters are polybutylene terephthalate (PBT), polyethylene terephthalate (PET), and polybutylene succinate (PBS), and examples that may be mentioned of suitable polyamides are PA 6 and PA 6.6, PA 6.10, PA 6. T, and the blends made of said polyesters and/or polyamides. It is preferable to use PBT as polyester, and to use PA 6 and/ or PA 6.6 as polyamide.

The semifinished products that can be produced in accordance with the invention vary widely, and preferably comprise a material selected from the group consisting of glass-and/or carbon-fiber-reinforced polyamides and polyesters (composite materials). Examples of the semifinished products can take the form of prefabricated forms of raw material, examples being panels, rods, and tubes. The shapes of the semifinished products can vary widely; they can also comprise mats, sheets, supports, such as T supports and double-T supports, U profiles, W profiles, and UW profiles, molded sections, e.g. for the automobile industry, and for housings, grips, and shanks, for a tool, and sports equipment, such as paddles or tennis rackets. In one embodiment, the semifinished products take the form of strands. The present invention therefore also provides the use of a semifinished product which can be produced by the process of the invention, in the form of mat, sheet, support, U profile, W profile, or UW profile, or in the form of molded section for the automobile industry, or for housings, grips, and shanks, for a tool, or sports equipment.

The pultrusion process is generally carried out at temperatures of from 50 to 100° C. above the melting point, in the case of semicrystalline thermoplastics. The chain extender is either added together with the thermoplastic pellets or takes the form of a melt and is metered into the thermoplastics melt. Saturation of the fibers is generally achieved continuously at rates in the region of a few meters per minute. Saturation of the fiber bundles is generally achieved with slightly superatmospheric pressure, but can be achieved in a wide range of pressures from atmospheric pressure up to about 10 bar.

The present invention further provides a process for producing fiber-reinforced polyester pellets for injection-molding applications, via comminution (pelletization) of semifinished products, where the semifinished products take the form of strands, and where the semifinished products can be produced by the process of the invention for producing semifinished products based on polymers.

### EXAMPLES

Some illustrative examples and results of experiments are described below. These are intended merely to illustrate the invention and are not intended in any way to restrict the scope of the invention.

Experiments were carried out on a plate rheometer with various reactive Joncrylen® materials.

The experimental conditions were as follows:

Test equipment: “Ares -2” deformation-controlled rheometer from TA Instruments

Test geometry: plate-on-plate, O/25 mm, h=1.0 mm

Test: time-sweep

Deformation: B27 E 30%/A 27 E 10%

Test temperature(s):

Ultramid® B27 E (PA6) at 260° C.

Ultramid® A27 E (PA6) at 280° C.

Ultradur® B2550 at 260° C.

Ecoflex® at 220° C.

Test time: 30 min

Preheat time: 5 min

Specimen preparation: specimens stored in vacuo at 40° C. for >7d

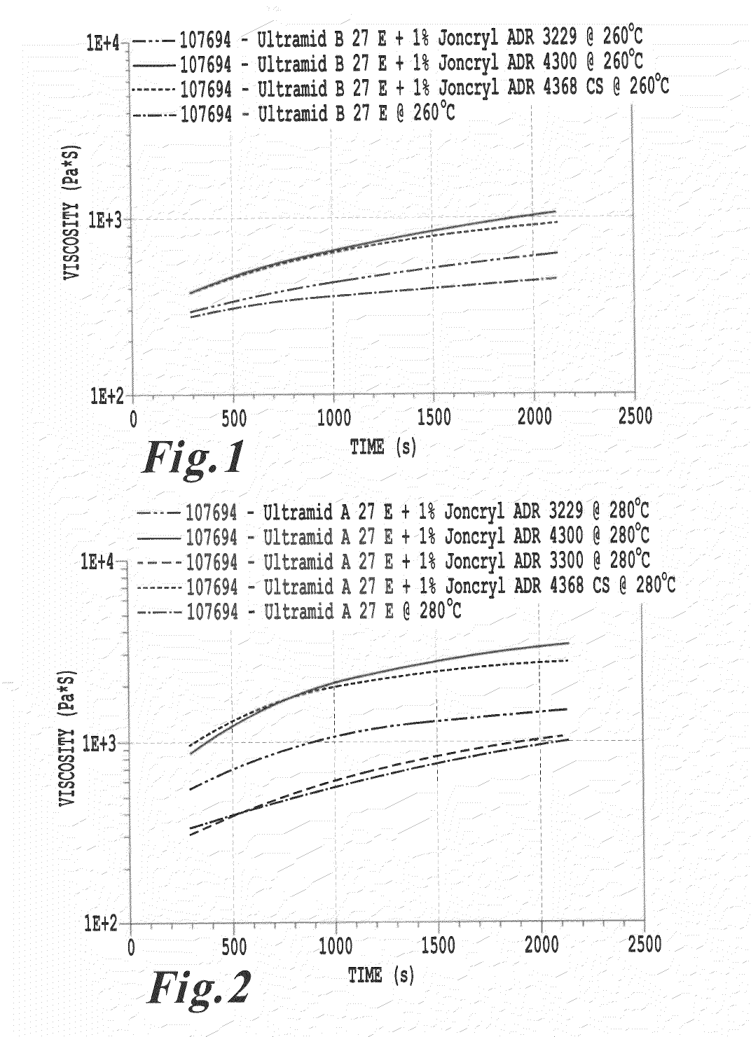

Experiment 1: Ultramid B® at 260 ° C.; see FIG. 1.

Experiment 2: Ultramid A® at 280 ° C.; see FIG. 2.

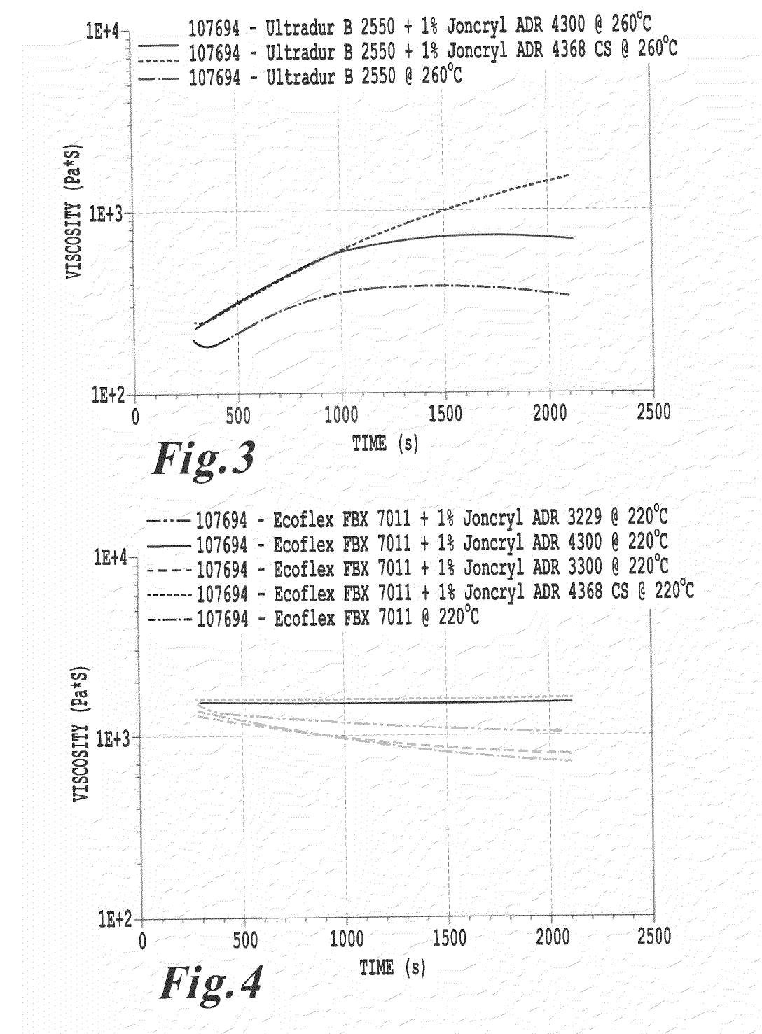

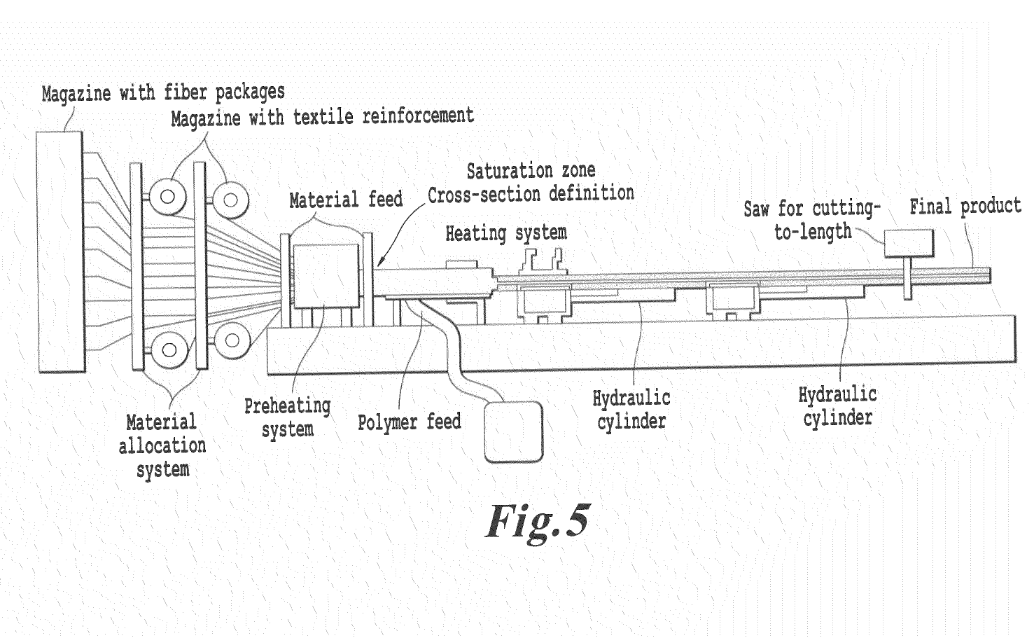

Experiment 3: Ultradur® at 260 ° C.; see FIG. 3.

Experiment 4: Ecoflex® at 220 ° C.; see FIG. 4.

Experiments 1 to 3 show by way of example the increase in viscosity of the polymer melt (corresponding to molecular-weight increase) on addition of small amounts of chain extenders.

The measurements from experiment 4 also show the increase in melt viscosity (correlated with increasing molecular weight) on addition of suitable chain extenders, taking the example of Ecoflex® F, a copolyester of adipic acid, terephthalic acid, and butane diol.

The advantages of the process of the invention in comparison with the processes known hitherto are therefore clear.

1. A process for producing semifinished products based on polyamides, via pultrusion, which comprises adding reactive chain extenders during the saturation of the polymer fibers, where the reactive chain extenders have been selected from the group consisting of molecules containing epoxy groups.

2. The process according to claim 1, where the semifinished product comprises a material selected from the group consisting of glass- and/or carbon-fiber-reinforced polyamides.

3. The process according to claim 1, where the polyamides have been selected from the group consisting of PA 6 and PA 6.6.

4. The process according to any of the preceding claims, where the reactive chain extenders are copolymers of styrene and of glycidyl acrylates.

5. The process according to any of the preceding claims, where the amount of the reactive chain extenders added is from 0.1% by weight to 10% by weight, based on the polymer.

6. A semifinished product obtainable by the process of any of claims 1 to 5.

7. The use of a semifinished product which can be produced by the process of any of claims 1 to 5, in the form of mat, sheet, support, U profile, W profile, or UW profile, or in the form of molded section for the automobile industry, or for housings, grips, and shanks, for a tool, or sports equipment.
